(19) United States
(12) Patent Application Publication
(10) Pub. No.: US 2008/0044254 A1
(43) Pub. Date: Feb. 21, 2008

(54) ANTI-THEFT FASTENER ASSEMBLY

(76) Inventor: Larry J. Wilson, Commerce Township, MI (US)

Correspondence Address: The MacLean-Fogg Company;c/o The Alden Law Group, 2122 York Rd, Suite # 180, Oak Brook, IL, 60523, US

(21) Appl. No.: 11/465,784

(22) Filed: Aug. 18, 2006

(51) Int. Cl. F16B 37/14

(52) U.S. Cl. 411/429; 411/910

(57) ABSTRACT

The present invention relates to an anti-theft fastener assembly that includes a fastener, an insert, and a shield. The insert is secured to the fastener and includes a security pattern that corresponds to a special security tool so that, once secured, the fastener can only be removed by the security tool. The shield is rotatably connected to the fastener and extends around the fastener to prevent access to a portion of the fastener.

### FIELD OF THE INVENTION

This invention relates to anti-theft threaded fasteners used to mount objects, such as vehicle wheels.

### BACKGROUND OF THE INVENTION

As demonstrated by U.S. Pat. No. 6,719,511, the disclosure of which is hereby incorporated herein by reference, anti-theft fasteners are used at times to attach wheels to vehicles. In most situations where anti-theft fasteners are employed to mount a vehicle wheel, the vehicle wheel is mounted by utilizing a plurality of standard wheel fasteners and one anti-theft wheel fastener.

One of the draw backs with previously manufactured anti-theft wheel fasteners is that their appearance is conspicuously different than the standard fasteners with which they are used in conjunction with. In addition to the deficiencies this creates aesthetically, a thief is usually able to easily identify and concentrate on attacking the anti-theft fastener among the wheel fasteners used to mount the wheel. Furthermore, because of their special security requirements, previously manufactured anti-theft wheel fasteners have been significantly more costly to produce when compared to standard wheel fasteners.

The presently preferred embodiment is directed to overcoming these and other disadvantages inherent in prior-art systems.

### SUMMARY OF THE INVENTION

The scope of the present invention is defined solely by the appended claims, and is not affected to any degree by the statements within this summary. Briefly stated, an anti-theft fastener assembly embodying features of the present invention comprises a fastener, an insert, and a shield. The insert is secured to the fastener and includes a security pattern that corresponds to a special security tool so that, once secured, the fastener can only be removed by the security tool. The shield is rotatably connected to the fastener and extends around the fastener to prevent access to certain portions of the fastener.

### BRIEF DESCRIPTION OF THE DRAWINGS

FIG. 1 depicts the fastener assembly of the presently preferred embodiment partially in section.

FIG. 2 depicts the fastener of the presently preferred embodiment in section.

FIG. 3 depicts the insert of the presently preferred embodiment.

FIG. 4 depicts the first end on the insert of the presently preferred embodiment.

FIG. 5 depicts the second end on the insert of the presently preferred embodiment.

FIG. 6 depicts the insert of the presently preferred embodiment and a sectional view of the fastener of the presently preferred embodiment.

FIG. 7 depicts the shield of the presently preferred embodiment.

FIG. 8 depicts the shield of the presently preferred embodiment in section.

FIG. 9 depicts the first end of the shield of the presently preferred embodiment.

FIG. 10 depicts the shield of an alternative embodiment.

FIG. 11 depicts the fastener of an alternative embodiment partially in section.

FIG. 12 depicts a fastener assembly of an alternative embodiment.

FIG. 13 depicts a fastener of an alternative embodiment.

FIG. 14 depicts a washer of an alternative embodiment.

FIG. 15 depicts a fastener assembly of an alternative embodiment.

FIG. 16 depicts the shield of the preferred embodiment prior to assembly onto the fastener.

### DETAILED DESCRIPTION OF THE PRESENTLY PREFERRED EMBODIMENT

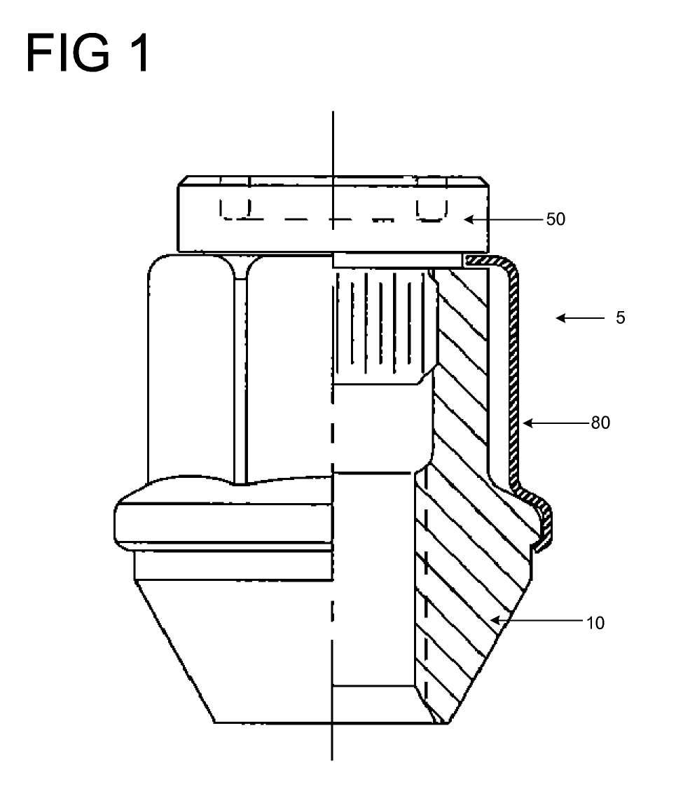

FIG. 1 depicts the presently preferred embodiment of a theft deterrent fastener assembly 5. As shown therein, the fastener assembly 5 includes a fastener 10, an insert 50, and a shield 80.

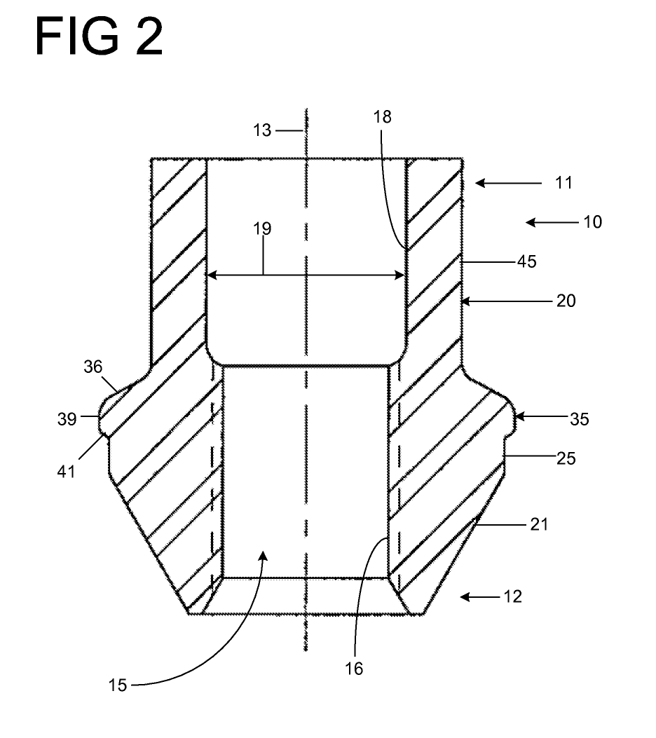

Turning now to FIG. 2, the fastener 10 is depicted as nut for mounting onto a bolt used to secure a wheel. The fastener 10 is provided with a first end 11 and a second end 12. As shown, a bore 15 preferably extends within the fastener 10 from the first end 11 to the second end 12. Within the bore 15 is a threaded portion 16 that extends from the second end 12 towards the first end 11 for a predetermined distance.

According to one aspect of the present invention, fastener 10 is adapted to retain the insert 50. In the preferred embodiment, extending within the bore 15, from the first end 11, is an insert securing surface 18 that is shaped to retain the insert 50. In the embodiment depicted, the insert securing surface 18 is generally cylindrical in shape and provided with a diameter 19. The diameter 19 is dimensioned so that the insert 50 is retained within the bore 15. In the preferred embodiment, the insert is retained through an interference fit.

The fastener 10 is provided with an outer surface 20 that includes a plurality of surfaces. As shown in FIG. 2, the outer surface 20 includes a bearing surface 21, which is located at the second end 12 of the fastener 10. The bearing surface 21 of the preferred embodiment depicted is adapted to seat in the well of a vehicle wheel. As shown, the bearing surface 21 is generally frusto-conical in shape; however, in alternative embodiments, the bearings surface 21 is generally spherically shaped or generally flat and oriented to be generally orthogonal to the axis 13 of the fastener 10.

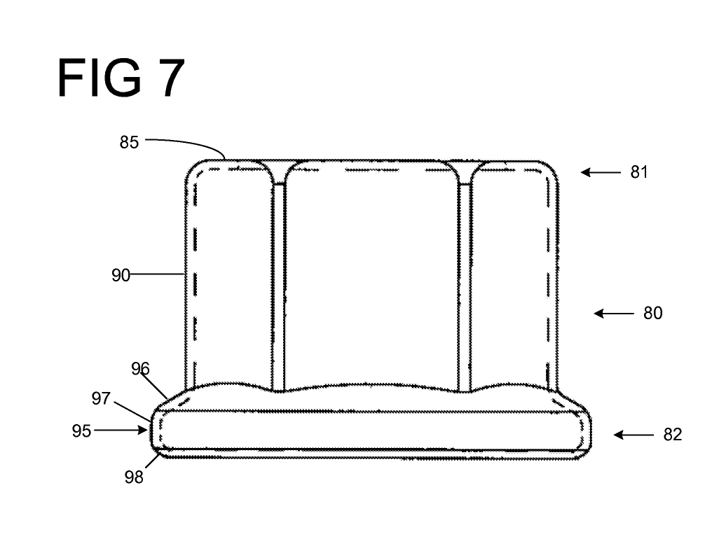

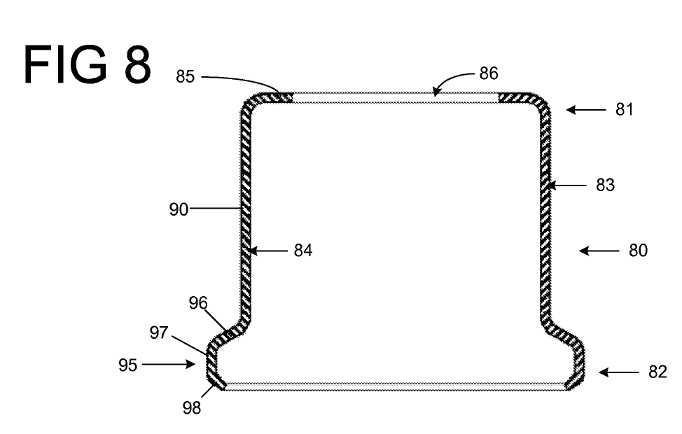

Located adjacent to the bearing surface 21 is a spacing surface 25. The spacing surface is adapted to space a second retaining portion 95 (shown in FIGS. 7 and 8) of the shield 80 from the bearing surface 21 of the fastener 10 so that when the fastener 10 is fastened to a mating threaded member, axial forces, which may dislodge or distort the shield 80 do not act upon the shield 80. As shown, the spacing surface 25 is a generally cylindrical surface; however, the spacing surface may be provided with a frusto-conical or curved shape, so long as when the shield is installed on the fastener 10, the second retaining portion 95 of the shield 80 is spaced from the bearing surface 21.

Located adjacent to the spacing surface 25 is a flange 35. In the preferred embodiment, the flange 35 extends radially outward relative to the bearing surface 21, the spacing surface 25, and a side wall 45 of the fastener 10. According to one aspect of the present invention, the flange 35 is configured to retain the shield 80 on the fastener 10. In the preferred embodiment, the flange 35 is configured to prevent axial displacement of the shield 80 relative to the fastener 10, while permitting relative rotation of the shield 80 relative to the fastener 10. In the embodiment depicted in FIG. 2, the flange 35 includes a first section 36, a second section 39, and a third section 41. As shown, the first section 36 extends, at least in part, radially outward from the side wall 45 and is preferably generally frusto-conical in shape, the second section 39 extends, at least in part, axially, from the first section 26 and is preferably generally cylindrical in shape, and the third section 41 extends, at least in part, radially towards the axis 11 from the second section 39 and is preferably generally frusto-conical in shape. In the preferred embodiment, the shield 80 is placed over the flange 35 and, then, at least a portion, of the second retaining portion 95 of the shield 80 is located under the flange 35, preferably via crimping.

In the preferred embodiment, the flange 35 is located adjacent to the side wall 45. According to one aspect of the preferred embodiment, the side wall 45 is adapted to be covered by the shield 80. According to another aspect of the present invention, the side wall 45 is shaped so that when the side wall 90 of the shield 80 extends around the side wall 45, the shield 80 will rotate relative to the fastener 10 prior to the fastener 10 loosening, once secured. According to one aspect of the preferred embodiment, the side wall 45 is adapted so that it is difficult for a tool to apply torque thereto. As shown, the side wall 45 is preferably generally cylindrical in shape. Accordingly, in the event the shield 80 becomes dislodged, it will be difficult for a tool, such as a wrench, to apply torque to the side wall 45.

According to one aspect of the present invention, the fastener 10 is fabricated from a metal. According to another aspect of the present invention, the fastener 10 includes a metal alloy. According to yet another aspect of the present invention, the fastener 10 includes a steel alloy, such as, for example grade 10b21. According to still another aspect of the presently present invention, the fastener includes a low, medium, or high carbon steel, such as, for example a grade ranging from 1015 through 1541. In embodiments wherein the fastener 10 is a nut it is preferable that the fastener 10 include a low to medium carbon steel, such as, for example, a grade ranging from 1015 through 1035 or where the step of heat treating is involved, an alloy steel, such as 10b21. In embodiments wherein the fastener 10 is a bolt it is preferable that the fastener 10 include a medium to high carbon steel, such as, for example, a grade ranging from 1038 through 1541 or an alloy steel, such as, for example, 4037. Although the presently preferred embodiment is fabricated from a steel metal, it is within the scope of the present invention to fabricate the fastener 10 from other materials, such as for example, an aluminum. Furthermore, the fastener 10 may be provided with a coating, including a low friction coating, such as PTFE.

According to one aspect of the present invention, the fastener 10 is fabricated by cold forming. According to another aspect of the present invention, the fastener 10 is fabricated through machining. According to yet another aspect of the present invention, the fastener 10 is fabricated through a combination of cold forming and machining. In the preferred embodiment, the fastener is fabricated by cold forming and then threads are provided via machining. Those skilled in the art will appreciate that it is within the scope of the present invention to fabricate the fastener 10 through casting, machining, hot forming, or cold forming, and that any combination thereof can be used to provide any aspect of the fastener 10.

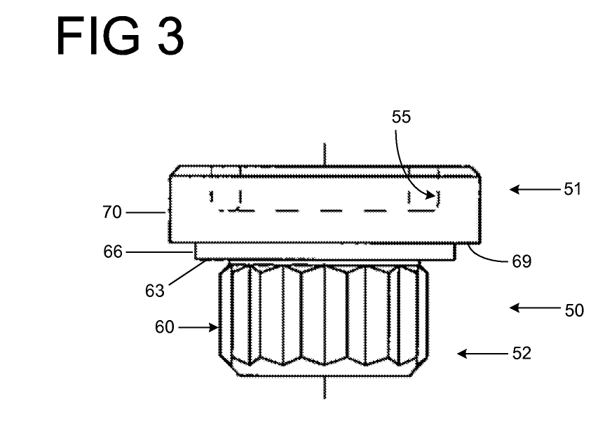

Turning now to FIG. 3, the insert 50 of the presently preferred embodiment is depicted. According to one aspect of the present invention, the insert 50 is adapted to receive torque from a security tool. According to another aspect of the present invention, the insert 50 is adapted to transmit torque to the fastener 10.

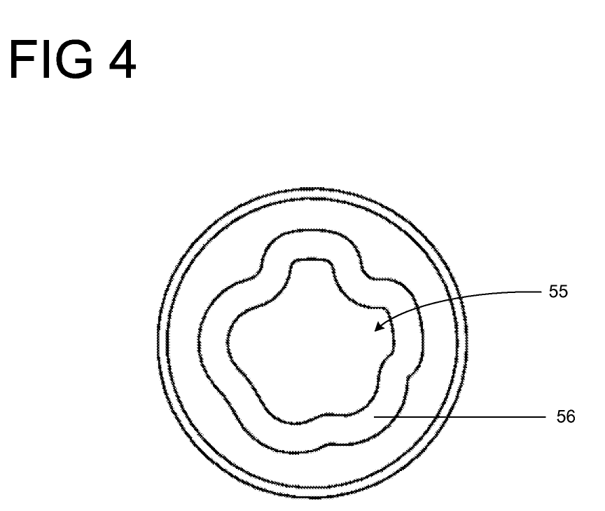

As shown in FIG. 3, the insert 50 includes a first end 51 and a second end 52. Located at the first end 51 of the presently preferred embodiment is a torque receiving structure 55. The torque receiving structure 55 is preferably an internal drive that is shaped to cooperate with a security tool to fastener and unfasten the fastener 10. As shown in FIG. 4, the torque receiving structure 55 is provided with a special security pattern 56 that is generally complementary to a security pattern on a special security tool (not shown). As a result only the special security tool can be used to unfasten the fastener 10 once it is secured to a mating threaded member. As shown, the special security pattern 56 is non-symmetrical and defined by a plurality of curved lines; however, it is within the scope of this invention for the security pattern to be provided with other shapes, so long as standard tools cannot be used to unfasten the fastener 10 once it is secured to a mating threaded member.

As FIG. 3 depicts a torque transmitting structure 60, which is preferably located at the second end 52 of the insert 50. According to one aspect of the present invention, the torque transmitting structure 60 is adapted to transmit torque to the fastener 10 in order to fasten and unfasten the fastener 10. According to another aspect of the presently preferred embodiment, the torque transferring structure 60 is adapted to prevent axial displacement of the insert 60 relative to the fastener 10. In the presently preferred embodiment, the torque transmitting structure 60 is an external drive that is retained within the insert securing surface 18 of the fastener 10 by an interference fit. The torque transmitting structure 60 is preferably press fit into the insert securing surface 18 of the bore 15. The amount of the interference fit is calculated so that axial displacement and relative rotation are precluded.

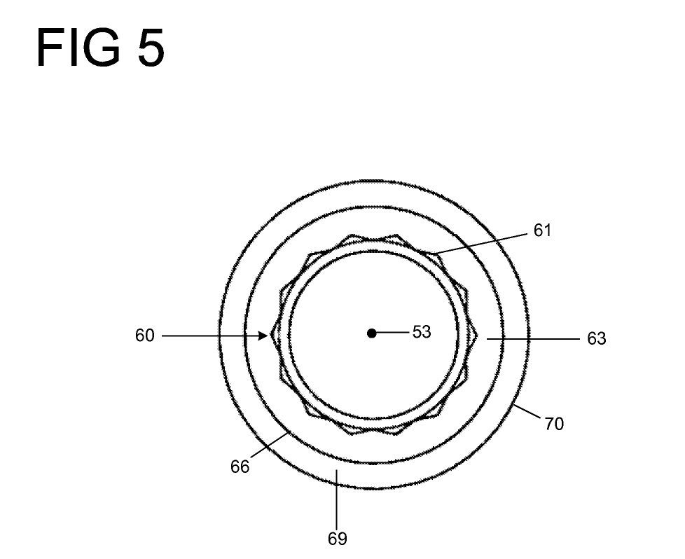

As shown in FIG. 5, the torque transmitting structure 60 is preferably an out-of-round surface, which is shown in the shape of a plurality of generally triangular cross-sectional shaped protrusions 61 that extend radially around the axis 53 of the insert 50. Although, the torque transmitting structure 60 of the presently preferred embodiment is provided with a plurality of triangular protrusions 61, those skilled in the art will appreciate that it is within the scope of the present invention to utilize other shapes, so long as relative rotation and axial displacement do not occur.

As shown in FIGS. 3 and 5, the insert 50 of the presently preferred embodiment includes a seating surface 65 that is located between the first and second ends 51, 52 of the insert 50. The seating surface 65 is adapted to seat on the first end 11 of the fastener 10 when the insert 60 is sufficiently inserted within the bore 15 of the fastener 10. In the embodiment depicted, the seating surface 65, extends, at least in part, radially outward relative to the torque transmitting structure 60 and is preferably generally annular in shape. Although the presently preferred embodiment includes a seating surface that is generally annular in shape, it is within the scope of the present invention for other shapes to be utilized. Furthermore, those skilled in the art will appreciate that it is within the scope of the present invention for the insert 50 to be fabricated without the seating surface 65.

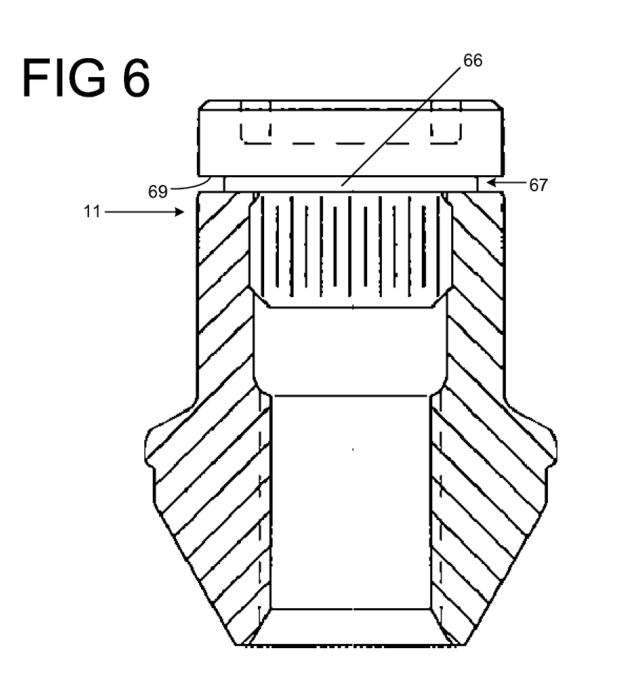

The insert 50 of the preferred embodiment is provided with at least one surface that cooperates with the first end 11 of the fastener 10 to define a groove 67 for accommodating a first retaining portion 85 of the shield 80. As shown in FIGS. 3 and 5, the insert 50 of the presently preferred embodiment includes a first grooved defining surface 66 and a second groove defining surface 69, which, as shown in FIG. 6, cooperate with the first end 11 of the fastener 10 to define a groove 67, which is preferably generally annular. In the preferred embodiment, the first groove defining surface 66 is shaped so that, in the event that the shield 80 becomes dislodged, it is difficult for a tool to grip and apply torque. As shown in FIGS. 3 and 5, the first groove defining surface 66 extends, at least in part, axially and is preferably generally cylindrical in shape. Also shown therein, the second groove defining surface 69 extends, at least in part, radially and is preferably generally annular in shape.

As shown in FIGS. 3 and 5, in the preferred embodiment, the insert 50 is provided with a side wall 70 that is located between the first and second ends 51, 52 of the insert 50. In the presently preferred embodiment, the side wall 70 is provided with a shape that is difficult for a tool to grip and apply torque. As shown in FIG. 3, the side wall extends, at least in part, axially, and is preferably generally cylindrical in shape.

In the preferred embodiment of the present invention, the insert 50 is fabricated from a metal. According to one aspect of the present invention, the insert 50 includes a metal alloy. According to another aspect of the present invention, the insert 50 includes a steel alloy, such as, for example grade 10b21. According to another aspect of the present invention, the insert 50 includes a high carbon steel, such as, for example a grade ranging from grade 1038 through grade 1541. According to yet another aspect of the present invention, the insert 50 includes a hardened stainless steel, such as grades 420 and 440C. Although the presently preferred embodiment is fabricated from a steel metal, it is within the scope of the present invention to fabricate the insert 50 from other materials, such as for example, a titanium.

According to one aspect of the present invention, the insert 50 is fabricated by cold forming. According to another aspect of the present invention, the insert 50 is fabricated through machining. According to yet another aspect of the present invention, the insert 50 is fabricated through a combination of cold forming and machining. In the preferred embodiment, the insert 50 is fabricated by cold forming and then security pattern is provided via machining; however, other security patterns could be provided via cold forming. Those skilled in the art will appreciate that it is within the scope of the present invention to fabricate the insert 50 through casting, machining, hot forming, or cold forming, and that any combination thereof can be used to provide any aspect of the insert 50.

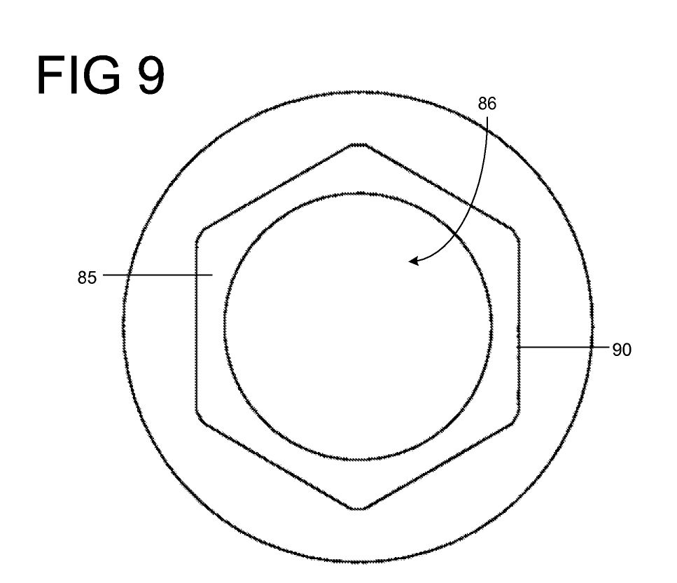

Turning now to FIGS. 7 and 8, the presently preferred embodiment of the shield 80 is depicted. The shield 80 of the presently preferred embodiment has the general appearance of a decorative cap for a standard hexagonal shaped wheel nut. As shown, the shield 80 includes a first end 81, a second end 82, an outer surface 83, and an inner surface 84. According to one aspect of the present invention, the shield 80 is preferably provided with at least one retaining portion that rotatably secures the shield 80 to the fastener 10. As shown in FIGS. 8 and 9, located at the first end 81 of the presently preferred embodiment is a first retaining portion 85. According to one aspect of the presently preferred embodiment, the first retaining portion 85 is adapted to secure the shield 80 to the fastener 10 so that once the fastener 10 is secured to a mating threaded component, an application of torque to the shield 80 will cause the shield 80 to rotate relative the fastener 10 prior to the fastener loosening.

In the presently preferred embodiment, the first retaining portion 85 is adapted to fit within the groove 66 defined by the fastener 10 and the insert 50. As shown best in FIG. 9, the first retaining portion 85 is preferably provided with an outer circumference that is generally hexagonal in shape. As shown in FIGS. 8 and 9, the first retaining portion 85 defines a preferably generally cylindrical opening 86. In the preferred embodiment, the opening 86 is dimensioned to accommodate the first groove defining surface 65 of the insert 50. In the preferred embodiment, when the first retaining portion 85 is located within the groove 66, the outer surface 83 of the first retaining portion 85 faces the second groove defining surface 69 on the insert 60 and the inner surface 84 of the first retaining portion 85 faces the first end 11 of the fastener 10. Although the presently preferred embodiment shown in FIGS. 8 and 9 includes the first retaining portion 95, it is within the scope of the present invention to fabricate the shield 80 without the first retaining portion 85.

As shown in FIGS. 7, 8, and 9 the shield 80 is provided with a side wall 90. In the preferred embodiment, the side wall 90 is located between the first retaining portion 85 and a second retaining portion 95. According to one aspect of the presently preferred embodiment, the side wall 90 is adapted to appear as though it is capable of transferring torque to the fastener 10. According to another aspect of the presently preferred embodiment, the side wall 90 is adapted to cover the side wall 45 of the fastener 10. As shown in FIGS. 7 and 9, the outer surface 84 of the side wall 90 on the shield 80 is preferably provided with an out of round shape, which in the preferred embodiment is generally hexagonal in shape shape. Accordingly, in the preferred embodiment, once the shield 80 is installed over the fastener 10, the fastener assembly 5 will, except for the security pattern of the torque receiving structure 55, generally appear to be a normal hexagonal shaped wheel fastener. However, since outer surface 20 of the fastener 10 is shaped so that torque cannot be applied thereto by the inner surface 83 shield 80, when the outer surface 83 of the side wall 90 is subjected to torque, the shield 80 will rotate relative to the fastener 10 prior to the fastener 10 loosening from a mating threaded member to which it is secured.

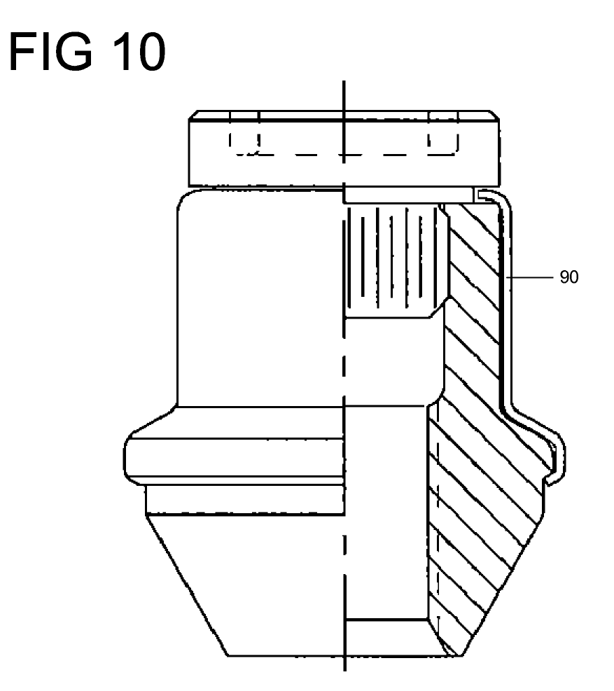

Although, the inner surface 84 of the side wall 90 of the presently preferred embodiment is provided with a shape that corresponds to the shape of the outer surface 83 and is preferably generally hexagonal, the inner surface 84 of the side wall 90 may be provided with any shape, including a generally cylindrical shape, as shown in FIG. 10, so long as the shield 80 rotates relative to the fastener 10 prior to the fastener 10 loosening once secured. Furthermore, although the outer surface 84 of the side wall 90 in the preferred embodiment is provided with a generally hexagonal shape, it is within the scope of the present invention for the outer surface 84 of the side wall 90 to be provided with other shapes, such as the generally cylindrical shape depicted in FIG. 10.

As shown in FIGS. 7 and 8, in the preferred embodiment the shield 80 is provided with a second retaining portion 95 that is located at the second end 82 of the shield 80. According to one aspect of the presently preferred embodiment, the second retaining portion 95 is adapted to prevent axial displacement of the shield 80 relative to the fastener 10. According to another aspect of the presently preferred embodiment, the second retaining portion 95 is adapted to secure the shield 80 around the fastener 10 whereby the shield 80, when torqued, will rotate relative to the fastener 10 prior to the fastener 10 loosening from a mating threaded member to which it is secured.

In the presently preferred embodiment, the second retaining portion 95 is secured to the flange 35 of the fastener 10. Preferably, at least a portion of the second retaining portion 95 is crimped around the flange 35. As shown in FIGS. 7 and 8, the second retaining portion 95 of the preferred embodiment includes a first portion 96 that extends radially outward from the side wall 90 and is generally frusto-conical in shape, a second portion 97 that extends from the first portion 96 and is generally cylindrical in shape, and a third portion 98 that extends radially inward from the second portion 97 and is generally frusto-conical in shape. Those skilled in the art will appreciate that it is within the scope of the present invention for the second retaining portion 95 to be provided with other shapes.

In the preferred embodiment of the present invention, the shield 80 is fabricated from a metal. According to one aspect of the present invention, the shield 80 includes a metal alloy. According to another aspect of the present invention, the shield 80 includes a steel alloy. According to another aspect of the present invention, the shield 80 includes a carbon steel. According to yet another aspect of the present invention, the shield 80 includes a stainless steel, such as, for example, grades 304, 430, 434, or 436. Although the presently preferred embodiment is fabricated from a stainless steel, it is within the scope of the present invention to fabricate the shield 80 from other materials. Those skilled in the art will appreciate that it is within the scope of the present invention to provide the shield 80 with a decorative coating, such as a chrome coating, or an anti-corrosive coating.

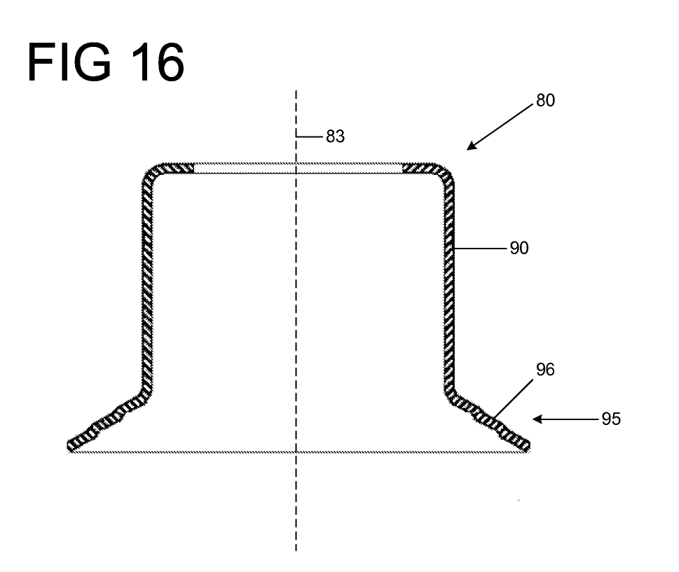

According to one of the present invention, the shield 80 is fabricated through cold drawing. According to another aspect of the present invention, the shield 80 is fabricated through stamping. In the preferred embodiment, the shield 80 is fabricated by a combination of cold drawing and stamping. The process begins by punching a generally round disk from a piece of sheet metal having a thickness that that ranges from 0.4 mm through 1.0 mm, and is preferably 0.5 mm. After the disk is provided, it is cold drawn by being run through a series of cupping operations which shape the disk into a generally cylindrical structure having a generally disk shaped closed end and a generally circular open end. In the next step, the generally cylindrical structure is cold drawn to provide a side wall 90 with the desired shape, which in the preferred embodiment is generally hexagonal. After the side wall is 90 is shaped, in the preferred embodiment, the second retaining portion 95 is provided by stamping. After this stage, as shown in FIG. 16, the second retaining portion 95 is preferably provided with only a first portion 96 that extends radially outward from the axis 83 and side wall 90 of the shield 80. After the side wall 90 is shaped, either before or after the second retaining portion 95 is provided, the closed end is punched out via stamping so that the first retaining portion 85 is preferably provided. In embodiments wherein the first retaining portion 85 is omitted, the entire closed end is punched to provide an opening that is shaped correspondingly to the shape of the side wall 90.

The shield 80 is then secured around the fastener 10 by first placing the shield 80 around the fastener 10 so that the first retaining portion 85 is seated on the first end 11 of the fastener 10. Afterwards, the torque transmitting structure 60 of the insert 50 is inserted within the insert securing surface 18 of the fastener 10. After the first retaining portion 85 is seated on the first end 11 of the fastener, either before of after the insert 50 is inserted within the fastener 10, the first portion 96 of the second retaining portion 95 is folded under the fastener 10 flange 35, preferably by crimping, to provide the second and third portions 39, 41 of the second retaining portion 95.

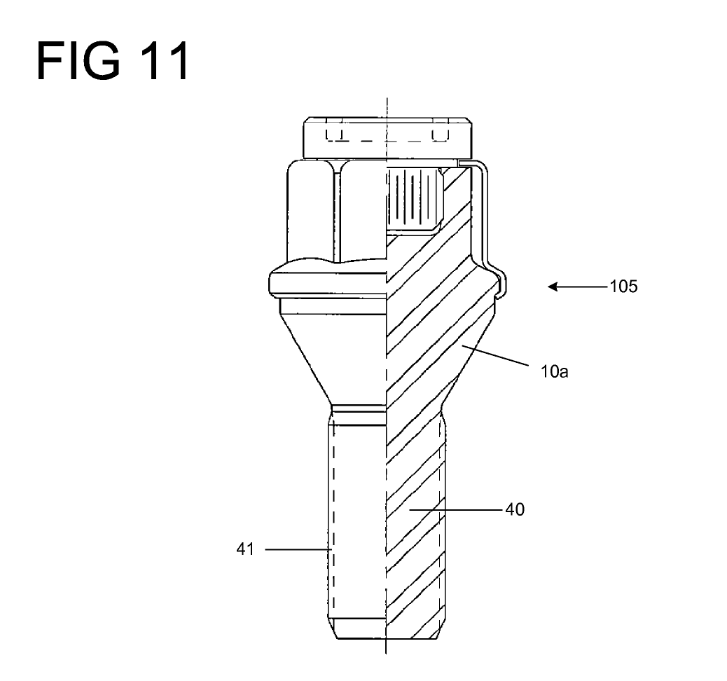

FIG. 11 depicts an alternative embodiment of the fastener assembly at 105. The fastener assembly 105 is similar to the fastener assembly 5, except that the fastener, which is designated at 10a, is a bolt provided with a shaft 40 located at the second end 12. As shown, at least a portion of the shaft 40 includes a threaded surface 41. According to one aspect of the present invention, the threaded surface 41 of the shaft 40 may be provided with the thread configurations disclosed in U.S. patent application Ser. No. 10/430,794, filed May 5, 2003, the disclosure of which is hereby incorporated herein by reference.

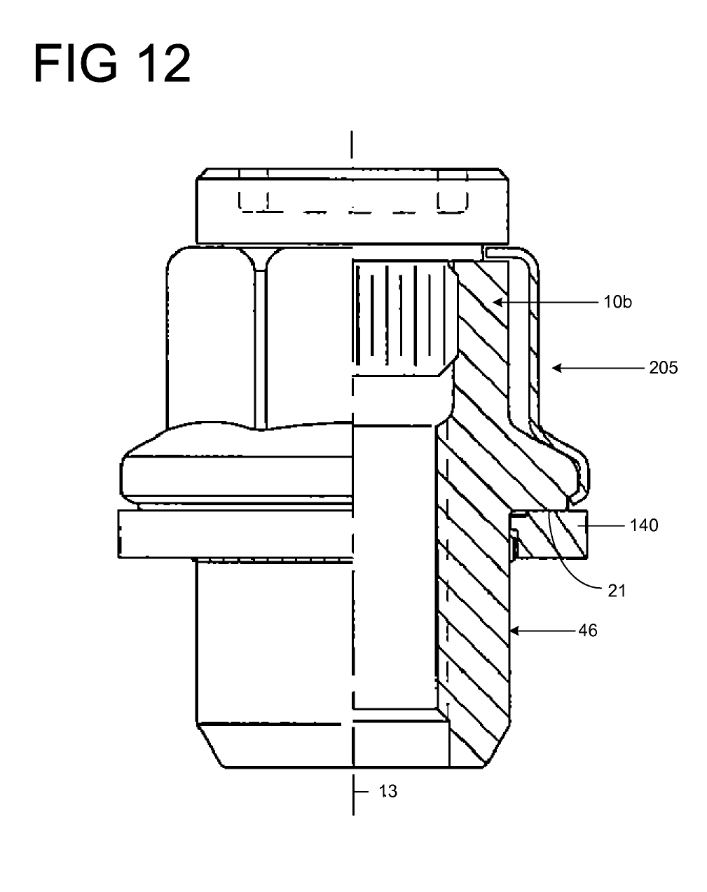

FIG. 12 depicts yet another alternative embodiment of the fastener assembly at 205. The fastener assembly 205 depicts various modifications that may be applied to either the fastener assembly 10 or the fastener assembly 105. As shown therein, the fastener, which is designated at 10b, is provided with a second side wall 46 and a generally flat bearing surface 21 that is orthogonal to the axis 13 of the fastener 10b. Additionally, the fastener assembly 110 further includes a washer 140.

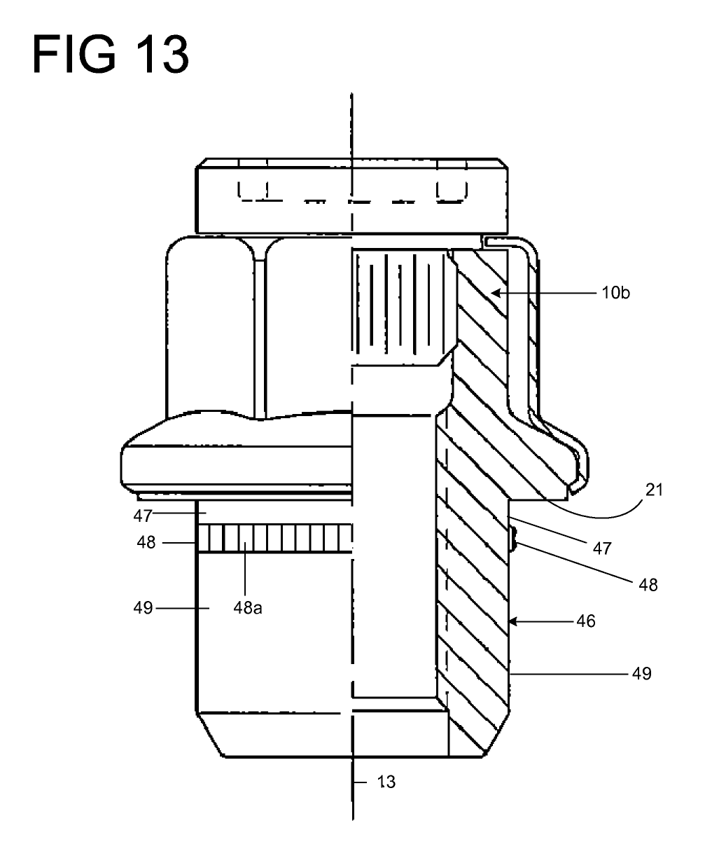

According to one aspect of the present embodiment, the second side wall 46 of the fastener 10b is adapted to fit within an opening defined by the surface being acted upon by the fastener. According to another aspect of the present embodiment, the second side wall 46 of the fastener 10b is shaped to retain the washer 140. As shown in FIG. 13 the side wall 46 is preferably generally cylindrical in shape. The side wall 46 of the embodiment depicted includes a first surface 47, a second surface 48, and third surface 49. The first surface 47 is located adjacent to the bearing surface 21 and is adapted to fit within an opening 76 of the washer 140 so that the washer 140 extends around the first surface 47 and rotates relative to the first surface 47. The second surface 48 is located between the first and third surfaces 47, 49 and shaped to prevent the washer 140 from disassociating from the fastener 10b. In the preferred embodiment, the second surface 48 radially protrudes relative to the first surface 47 and the second surface 49. As shown in FIG. 13, the second surface 48 preferably includes a plurality of raised knurls 48a that protrude relative to the first and second surfaces 47, 49. The knurls 48a are dimensioned so that the inner surface 150 of the washer 140 can be forced over the second surface 48 so that the washer 140 will be captured around the first surface 47 as shown in FIG. 12. Located adjacent to the second surface 48 is the third surface 49, which is preferably generally cylindrical in shape and adapted to be located within the opening defined by the surface being acted upon by the fastener assembly 205.

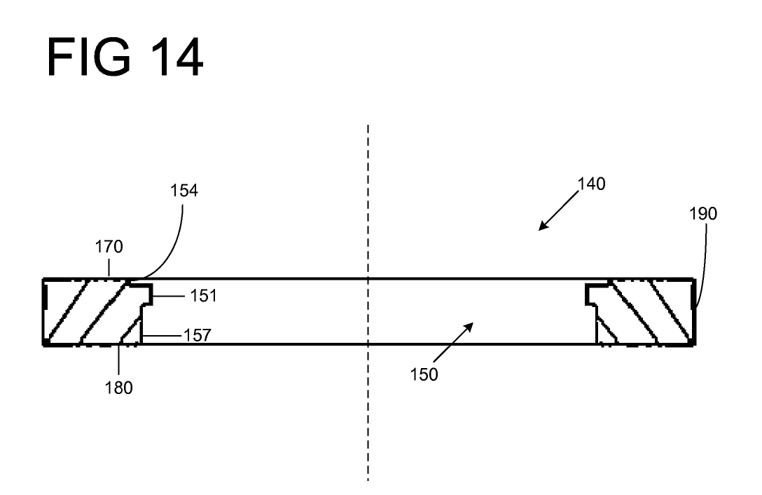

FIG. 14 depicts the preferred washer 140 of this embodiment. The washer 140 is preferably stamped from a low carbon steel, such as grade 1010. As shown in FIG. 14, the washer 140 is preferably generally annular in shape and includes an inner surface 150, a first end surface 170, a second end surface 180, and an outer surface 190. When the washer 140 is located around the fastener 10b, the first end surface 170 faces the bearing surface 21 on the fastener 10b, the second end surface 180 is positioned to face a surface that is being acted upon by the fastener 10, and the inner surface 150 is located radially around the second side wall 46, whereby the inner surface 150 faces the second side wall 46. As shown in FIG. 14, the first and second end surfaces 170, 180 are generally annular surfaces and the outer surface 190 is preferably provided with a generally cylindrical shape.

The inner surface 150 is configured to retain the washer 140 around the fastener 10b. As shown in FIG. 14, the inner surface 150 preferably includes a plurality of sections that have a plurality of diameters. In the embodiment depicted, the inner surface 150 includes a first section 151, a second section 154, and a third section 157. As shown, the sections 151, 153, 155 are preferably generally cylindrical in shape. The second section 154 is located adjacent to the first end section 170 and provided with a diameter and an axial length. The diameter of the second section 154 measures greater than the diameters of the first and third section 151, 157. The axial length measures less than the axial lengths of the respective first and third sections 151, 157. Also shown, the diameter of the first section 151 measures less than the diameter of the third section 157 and the axial length of the first section 151 measures less than the axial length 159 of the third section 157. Advantageously, the first section 151 protrudes radially inward relative to the second and third sections 154, 157.

Advantageously the first section 151 is dimensioned to frictionally engage the second surface 48 of the second side wall 46. The first section 151 of the washer 140 is configured to be forced over the second surface 48 of the fastener 10b so that once installed around the fastener 10b, the washer 140 can only be removed by again forcing the first section 151 over the second surface 48 in the opposite direction. Those skilled in the art will appreciate that the increased diameter of the second section 154 imparts a greater flexibility into the first section 51 during assembly. As shown in FIG. 12, the diameter of the third section 157 is dimensioned so that the third section 157 extends rotatably around the second surface 48 after assembly.

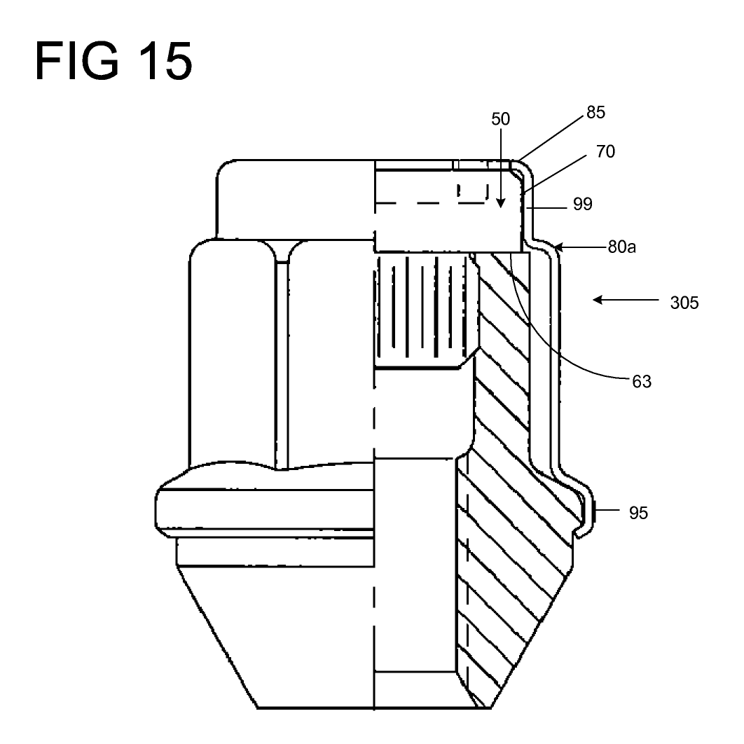

FIG. 15 depicts still another alternative embodiment of the fastener assembly at 305. The fastener assembly 305 depicts various modifications that may be applied to the fastener assemblies 10, 105, or 205. As shown, the insert 50 is not provided with groove defining surfaces 66, 69 and the seating surface 63 abuts the side wall 70. Also shown, the fastener assembly 305 includes a shield 80a that is provided with a second side wall 99 that is located around the side wall 70 of the insert 50. Also shown, therein, the first retaining portion 85 retains the shield 80 around the fastener 10 by extending over the first end 51 of the insert 50. Although the embodiment depicted includes the first retaining portion 85, it is within the scope of the present invention to fabricate the shield 80a without the first retaining portion 85.

While this invention has been particularly shown and described with references to preferred embodiments thereof, it will be understood by those skilled in the art that various changes in form and details may be made therein without departing from the spirit and scope of the invention as defined by the appended claims.

I claim:

1. An anti-theft fastener, comprising:
a) a fastener provided with an insert securing surface, a bearing surface, a side wall, and a flange that protrudes a radially outward with respect to the bearing surface;
b) an insert provided with a torque receiving structure and a torque transmitting structure, wherein:
i) the torque receiving structure is provided with a security pattern;
ii) the torque transmitting structure is secured to the insert securing surface of the fastener;
c) a sheet metal shield provided with retaining portion and a side wall, wherein:
i) the shield is rotatable relative to the fastener;
ii) the retaining portion is located, at least in part, under the flange of the fastener; and
iii) the side wall of the shield is located around the side wall of the fastener.

2. The anti-theft fastener according to claim 1, wherein the retaining portion includes a first portion that is located axially above the flange, a second portion that is located radially around the flange, and a third portion that is located, at least in part, axially below the flange.

3. The anti-theft fastener according to claim 1, further comprising another retaining portion that is provided on the shield and located within a groove defined by the insert and the fastener.

4. The anti-theft fastener according to claim 1, further comprising another retaining portion on the shield that extends over a first end of the insert.

5. The anti-theft fastener according to claim 1, further comprising a spacing surface that is provided on the fastener and that axially spaces the retaining portion of the shield from the bearing surface of the fastener.

6. The anti-theft fastener according to claim 1, wherein the side wall on the shield includes an outer surface that is generally cylindrical in shape.

7. The anti-theft fastener according to claim 1, wherein the side wall on the shield includes an outer surface that is generally cylindrical in shape.

8. The anti-theft fastener according to claim 1, further comprising a washer that defines an opening and contacts the bearing surface of the fastener.

9. The anti-theft fastener according to claim 1, wherein the side wall on the fastener is generally cylindrical in shape.

10. An anti-theft fastener, comprising:
a) a fastener provided with an insert securing surface, a side wall, and a bearing surface;
b) an insert provided with a torque receiving structure and a torque transmitting structure, wherein:
i) the torque receiving structure is provided with a security pattern;
ii) the torque transmitting structure is secured to the insert securing surface of the fastener; and
c) a sheet metal shield that is rotatable with respect to the fastener and provided with a side wall that includes an outer surface that is generally hexagonal in shape.

11. The anti-theft fastener according to claim 11, wherein the side wall of the shield is provided with an inner surface that is generally hexagonal in shape.

12. The anti-theft fastener according to claim 10, wherein:
a) the fastener is provided with a first end and a second end; and
b) the insert is provided with a seating surface that contacts the first end of the fastener.

13. The anti-theft fastener according to claim 10, further comprising a washer that defines an opening and contacts the bearing surface of the fastener.

14. An anti-theft fastener, comprising:
a) a fastener provided with an insert securing surface, a side wall, a bearing surface, and a flange that protrudes a radially outward with respect to the bearing surface;
b) an insert provided with a torque receiving structure and a torque transmitting structure, wherein:
i) the torque receiving structure is provided with a security pattern;
ii) the torque transmitting structure is secured to the insert securing surface of the fastener;
c) a sheet metal shield that is rotatable relative to the fastener and provided with a first retaining portion, a second retaining portion, and a side wall, wherein
i) the first retaining portion that is located axially above a first end of the fastener;
ii) the second retaining portion is, at least in part, located axially below the flange of the fastener;
iii) the side wall of the shield is located around the side wall of the fastener; and
iv) the side wall of the shield is provided with an outer surface that is generally hexagonal in shape.

15. The anti-theft fastener according to claim 14, wherein the second retaining portion includes a first portion that is located axially above the flange, a second portion that is located radially around the flange, and a third portion that is located, at least in part, axially below the flange.

16. The anti-theft fastener according to claim 14, wherein the first retaining portion of the shield is located within a groove defined by the insert and the fastener.

17. The anti-theft fastener according to claim 14, wherein the first retaining portion extends over the first end of the insert.

18. The anti-theft fastener according to claim 14, wherein the side wall of the shield is provided with an inner surface that is generally hexagonal in shape.

19. The anti-theft fastener according to claim 14, wherein the shield is provided with a thickness that ranges from 0.4 mm through 1.0 mm.

20. The anti-theft fastener according to claim 14, further comprising a spacing surface that is provided on the fastener and that axially spaces the second retaining portion of the shield from the bearing surface of the fastener.
